(19) United States
(12) Patent Application Publication
(10) Pub. No.: US 2009/0180455 A1
(43) Pub. Date: Jul. 16, 2009

(54) METHOD AND SYSTEM FOR CQI BASED ADAPTIVE DIAGONAL LOADING FOR DMI-EQ IN HSDPA RECEIVERS

(76) Inventors: Mukundan Ranganathan, San Diego, CA (US); Li Fung Chang, Holmdel, NJ (US); Abhinav Prasad, Woodbridge, NJ (US); Nelson Sollenberger, Farmingdale, NJ (US); Jun Wu, San Diego, CA (US)

Correspondence Address: MCANDREWS HELD & MALLOY, LTD, 500 WEST MADISON STREET, SUITE 3400, CHICAGO, IL, 60661, US

(21) Appl. No.: 12/260,591

(22) Filed: Oct. 29, 2008

Related U.S. Application Data
(60) Provisional application No. 61/021,220, filed on Jan. 15, 2008.

(51) Int. Cl. H04B 7/216

(52) U.S. Cl. 370/342

(57) ABSTRACT

Aspects of a method and system for CQI based adaptive diagonal loading for DMI-EQ in HSDPA receivers. A HSDPA enabled handset may comprise a minimum-mean-square (MMSE)-based direct matrix inversion (DMI) equalizer (DMI-EQ) for an advanced signal processing. The DMI-EQ may receive HSDPA signal in consecutive transmission time intervals (TTIs). A diagonal loaded DMI may be used for a robust solution of equalizer weights. The DMI diagonal loading coefficients may be determined based on the CQI value of the current TTI and apply to the DMI-EQ for the next TTI. The determined CQI may be derived from SNR information estimated via a reference signal in the received signal. A look-up table mechanism is provided to select a set of DMI diagonal coefficients for a determined CQI and a particular modulation type. The look-up table may comprise mappings between the CQI for a particular modulation type and various DMI diagonal coefficients.

### CROSS-REFERENCE TO RELATED APPLICATIONS/INCORPORATION BY REFERENCE

This patent application makes reference to, claims priority to and claims benefit from U.S. Provisional Patent Application Ser. No. 61/021,220 filed on Jan. 15, 2008.

The above stated application is hereby incorporated herein by reference in its entirety.

### FIELD OF THE INVENTION

Certain embodiments of the invention relate to communication systems. More specifically, certain embodiments of the invention relate to a method and system for CQI based adaptive diagonal loading for DMI-EQ in HSDPA receivers.

### BACKGROUND OF THE INVENTION

High Speed Downlink Packet Access (HSDPA) is a packet-based data service for W-CDMA and is capable of providing theoretical peak data rates of up to 14.4 Mbps by utilizing adaptive modulation and coding (AMC), hybrid ARQ (HARQ), and fast MAC scheduling. In a HSDPA system, downlink data transmissions are typically designed to be orthogonal at a transmitter. An orthogonal code set is used to combine and separate user data frames. However, the code orthogonality can be destroyed by multiple access interference (MAI) caused by, for example, multipath fading, multiuser interference, and interference from other cells, thereby resulting in significant inter-code/inter-path interference at a receiver. In order to mitigate multiple access interference (MAI), various sophisticated signal processing techniques such as equalization may be used at the receiver for better performances in multi-user conditions.

In WCDMA downlink, a code multiplexed pilot signal has been inserted to aid with channel estimation and/or filter update. Various pilot symbol assistant equalization techniques have been studied for the HSDPA. The MMSE criterion attempts to find a weight vector that will minimize the Mean Squared Error (MSE) between a received signal and some desired (or reference) signal.

Further limitations and disadvantages of conventional and traditional approaches will become apparent to one of skill in the art, through comparison of such systems with some aspects of the present invention as set forth in the remainder of the present application with reference to the drawings.

### BRIEF SUMMARY OF THE INVENTION

A method and/or system for CQI based adaptive diagonal loading for DMI-EQ in HSDPA receivers, substantially as shown in and/or described in connection with at least one of the figures, as set forth more completely in the claims.

These and other advantages, aspects and novel features of the present invention, as well as details of an illustrated embodiment thereof, will be more fully understood from the following description and drawings.

### BRIEF DESCRIPTION OF SEVERAL VIEWS OF THE DRAWINGS

FIG. 1 is a diagram system that enables CQI based adaptive diagonal loading for DMI-EQ in a HSDPA receiver, in accordance with an embodiment of the invention.

FIG. 2 is a block diagram illustrating a HSDPA receiver, in accordance with an embodiment of the invention.

FIG. 3 is a block diagram illustrating a loading factor generator, in accordance with an embodiment of the invention.

FIG. 4 is an exemplary flow chart for determining DMI diagonal loading coefficients based on CQI information, in accordance with an embodiment of the invention.

### DETAILED DESCRIPTION OF THE INVENTION

Certain embodiments of the invention may be found in a method and system for CQI based adaptive diagonal loading for DMI-EQ in HSDPA receivers. In various aspects of the invention, a HSDPA enabled handset may be operable to receive a radio signal transmitted via HSDPA technology. The radio signal may be received in various consecutive transmission time intervals (TTI) at the receiver of the HSDPA enabled handset. The channel quality indicator (CQI) may be derived for each of the TTIs. The received radio signal may be processed at the receiver via various advanced signal processing methods such as a MMSE-based DMI (direct matrix inversion) equalizer (DMI-EQ). The DMI-EQ may use a diagonal loaded DMI for a robust solution of equalizer weights. The DMI diagonal loading coefficients may be determined based on the derived CQI value for a current transmission time interval. The derived DMI diagonal loading coefficients may be applied to calculate, per TTI, the EQ weights to be used in the DMI-EQ for equalizing the received radio signal in a subsequent transmission time interval. The derived DMI diagonal loading coefficients may be scaled by the Automatic Gain Control (AGC) gain prior to being communicated to the DMI-EQ. The derived CQI may be obtained based on estimated SNR information of the received radio signal. The SNR information may be estimated via a reference signal in each transmission interval.

In a HSDPA system, the modulation information in the received radio signal is decoded as often as every TTI. Therefore, the DMI-EQ may be updated when the CQI information changes, that is, every TTI. To reduce computational complexity in determining DMI diagonal coefficients, a DMI loading factor generator may use a look-up table to map a particular set of DMI diagonal coefficients for a determined CQI with a modulation type. The look-up table, which may be pre-loaded to the HSDPA enabled handset, may comprise mappings between various CQI for a particular modulation type and a plurality of DMI diagonal coefficients.

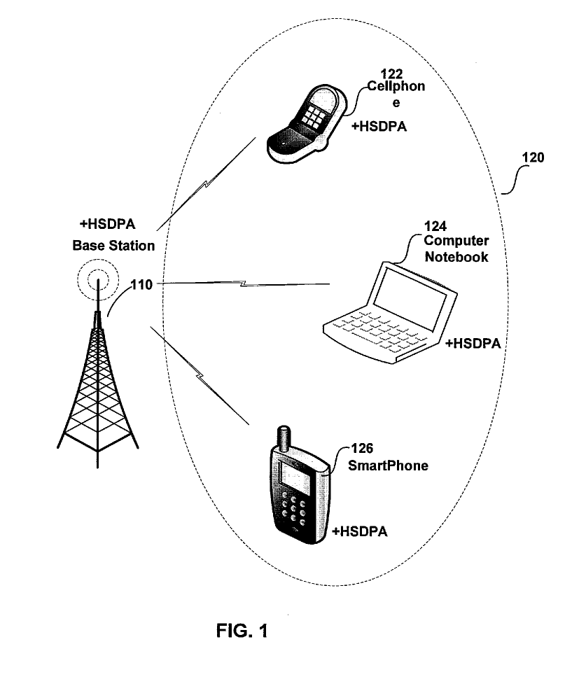

FIG. 1 is a diagram system that enables CQI based adaptive diagonal loading for DMI-EQ in HSDPA receiver, in accordance with an embodiment of the invention. Referring to FIG. 1, there is shown a base station 110, a plurality of HSDPA enabled handset devices 120, of which a cell phone 122, a notebook 124, and a smart phone 126 are illustrated.

The base station 110 may comprise suitable logic, circuitry and/or code that may enable scheduling communication resources in both uplink and downlink to various mobiles in a timely manner. The base station 110 may receive and/or transmit radio frequency signals from/to plural handset devices across a W-CDMA radio network. The base station 110 may be capable of supporting HSDPA and other downlink technologies.

The HSDPA enabled handset devices 120 may comprise suitable logic circuitry and/or code that may be enabled to receive and/or transmit radio frequency signals from and/or to the base station 110 across a W-CDMA radio network, respectively. The HSDPA enabled handset devices 120 may be enabled to apply various signal processing techniques such as equalization to improve the receiver performances in multi-user conditions. A MMSE-based equalization may be utilized to mitigate the effect of MAI for the HSDPA enabled handset devices 120. The MMSE-based equalization may handle various HSDPA categories for the HSDPA enabled handset devices 120 and may be implemented adaptively. The weights used for the MMSE-based equalization may be calculated by using direct matrix inversion (DMI) method and the DMI diagonal loading coefficients may be updated based on channel quality indicator (CQI) associated with incoming HSDPA signals.

In operation, a signal may be transmitted via HSPDA from the base station 110 to the HSDPA enabled handset 120 such as the cell phone 122. The cell phone 122 may actually receive the transmitted signal via one or more multipath. The cell phone 122 may use an advanced receiver such as an adaptive MMSE equalizer receiver to minimize interference of the received signal. The equalizer weights may be calculated by using DMI. The DMI diagonal coefficients may be updated based on CQI information associated with the received signals.

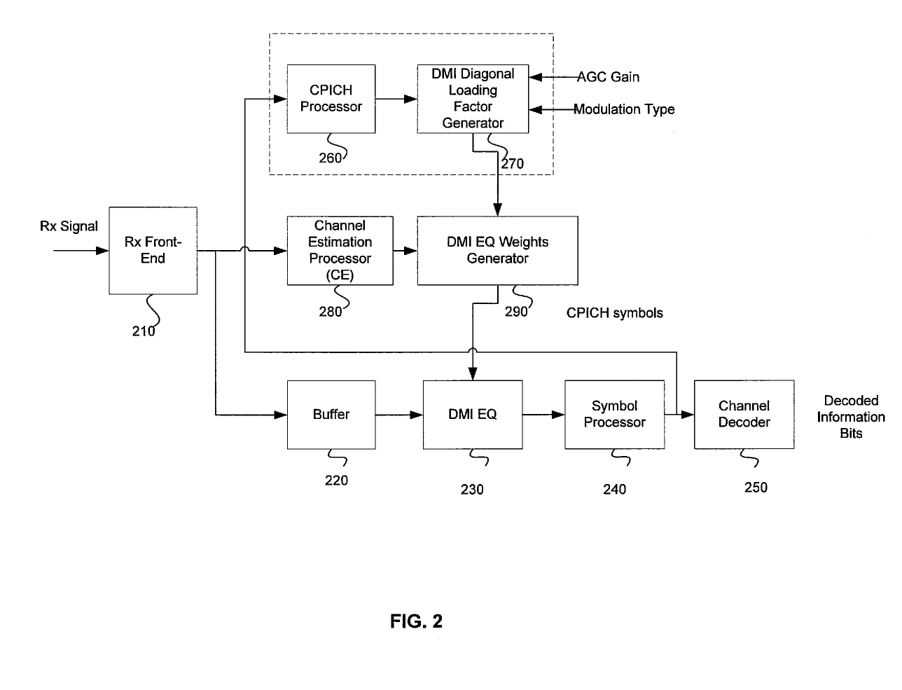

FIG. 2 is a block diagram illustrating a HSDPA receiver, in accordance with an embodiment of the invention. Referring to FIG. 2, there is shown a RX Front-End 210, a buffer 220, a DMI equalizer (EQ) 230, a symbol processor 240, a channel decoder 250, a CPICH processor 260, a direct matrix inversion (DMI) diagonal loading factor generator 270, a channel estimation processor 280, a direct matrix inversion (DMI) equalizer (EQ) weights generator 290.

The Rx front-end 210 may comprise suitable logic, circuitry, and/or code that may enable processing of received RF signals. The Rx front-end 210 may enable conversion of the received RF signal to a baseband frequency signal and enable analog-to-digital conversion of the baseband signal components. The digital baseband signal may be processed via AGC and pulse shaping.

The buffer 220 may comprise suitable logic circuitry and/or code that enable storage of incoming signals received through the Rx Front-End 210 in order to be delay-matched and/or equalized by using weights calculated by the DMI generator 290.

The DMI equalizer (EQ) 230 may comprise suitable logic circuitry and/or code that may enable interference suppression and compensation for some radio impairments. In this regard, the DMI EQ 230 may be implemented as a delay-tapped feed-forward filter with tap weights calculated via the DMI EQ weights generator 290.

The symbol processor 240 may comprise suitable logic circuitry and/or code that may enable generating symbols for various physical channels such as, for example, HS-SCCH (High Speed Shared Control Channel) and/or HS-PDSCH (High Speed Physical Downlink Shared Channel) by using corresponding channel specific codes such as a scrambling code and a set of channelization codes. The symbol processor 240 may comprise a bank of de-spreaders, which may be operable to process multiple physical channels such as HS-SCCH and/or HS-PDSCH in parallel for various physical channel specific symbols. For example, the output of the symbol processor 240 may comprise HS-SCCH symbols and/or HS-PDSCH symbols, which may be communicated to the channel decoder 250 for subsequent use.

The channel decoder 250 may comprise suitable logic circuitry and/or code that may be enabled to fix errors in the received data with system redundancy information embedded in the received data. The channel decoder 250 may determine the most possible source data sequence transmitted. The output of the channel decoder 250 may provide specific information transmitted. For example, the channel decoder 250 for HS-SCCH may generate control signals for the HS-PDSCH, such as the number of codes in the HSPDSCH, new data indicator, and modulation type (QPSK or 16QAM). The channel decoder 250 may perform the decoding process every TTI (transmission time interval).

The CPICH processor 260 may comprise suitable logic circuitry and/or code that may be enabled to process CPICH to generate received signal energy per chip (RSCP). The CPICH processor 260 may be enabled to estimate a signal noise ratio (SNR) indicating a ratio of desired signal power to noise. The SNR may be estimated based on CPICH RSCP, noise variance, and power differences allocated on the CPICH and HS-PDSCH, respectively.

The DMI diagonal loading factor generator 270 may comprise suitable logic circuitry and/or code that may enable generating DMI diagonal loading coefficients based on, for example, CQI, modulation type, and AGC. The CQI may be derived based on the CPICH RSCP, noise variance, and power allocation on HS-PDSCH, respectively. The modulation type information carried by HS-SCCH may be provided by the channel decoder 250. The AGC information may be fed by the output of the Rx Front-End 210. The updates of the DMI diagonal loading coefficients may be executed in instances where there may be a change in CQI. Each CQI may have a specific relation with SNR (signal noise ratio). The SNR may be provided by the CPICH processor 260. A unique CQI value may be indicated for a given SNR along with a particular modulation type. In HSDPA, the CQI may be updated every TTI. Based on the CQI value determined in the current TTI, the DMI diagonal loading factor generator 260 may be enabled to provide the DMI diagonal loading coefficients to be used for next TTI and so on.

The channel estimator 280 may comprise suitable logic circuitry and/or code that may enable estimating channel conditions based on received CPICH signal. The estimated channel conditions may be communicated with the DMI EQ weights generator 290 for later use.

The DMI EQ weights generator 290 may comprise suitable logic circuitry and/or code that may be enabled to produce a set of DMI EQ weights. The set of the DMI EQ weights may be determined based on the estimated channel information from the channel estimation processor 280. In this regard, the set of the DMI EQ weights may be calculated by using a minimum mean square error (MMSE) algorithm via a direct matrix inversion (DMI). To improve the conditioning of the matrix to be inverted, the diagonal components of the matrix may be scaled by a set of diagonal loading coefficients from the DMI diagonal loading factor generator 270 prior to inversion.

In operation, a radio signal transmitted via HSDPA technology may be received at the RX Front-End 210. The received radio signal may be processed via, for example, ADC and/or AGC, at the RX Front-End 210. The updated AGC information may be passed to the DMI diagonal loading factor generator 270. The output of the RX Front-End 210 may be stored in the buffer 220 first and then communicated with the DMI EQ 230. The output of the DMI EQ 230 may be passed to the symbol processor 240. The symbol processor 240 may generate various physical channel specific symbols such as, for example, HS-SCCH symbols and HS-PDSCH symbols. The HS-SCCH symbols and HS-PDSCH symbols may be fed to the channel decoder 250. The channel decoder 250 for HS-SCCH may generate control information such as the number of codes in the HSPDSCH, new data indicator, and modulation type (QPSK or 16QAM), respectively. The generated control information may be provided to the DMI diagonal loading factor generator 270. The DMI diagonal loading factor generator 270 may be enabled to derive diagonal loading coefficients based on the estimated CQI values from the CPICH processor 260 and the modulation type information from the channel decoder 250. A set of DMI diagonal coefficients may be selected by the DMI diagonal loading factor generator 270 based on a given CQI, a particular modulation type, and AGC information from the RX Front-End 210. The selected set of the DMI diagonal coefficients in the current TTI may be used by the DMI EQ weights generator 290 and the DMI EQ 230 for next TTI.

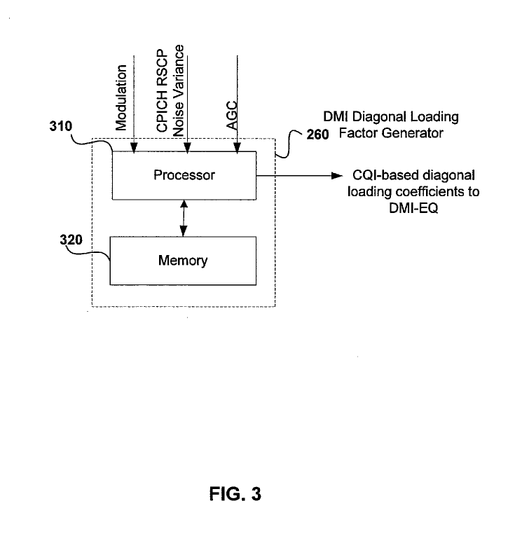

FIG. 3 is a block diagram illustrating a loading factor generator, in accordance with an embodiment of the invention. Referring to FIG. 3, there is shown a DMI diagonal loading factor generator 270 comprising a processor 310 and a memory 320.

The processor 310 may comprise suitable logic, circuitry and/or code that may be enabled to generate the DMI diagonal loading coefficients based on CQI, modulation type, and received signal power AGC. The processor 310 may be configured to determine DMI diagonal loading coefficients used for the next TTI. The processor 310 may be enabled to select a CQI value for an estimate SNR from the CPICH processor 260 and a particular modulation type. To lower the complexity of matrix inversion in the DMI EQ 290, the processor 310 may select DMI diagonal coefficients by using a look-up table comprising the mappings between CQI and DMI diagonal coefficients for a particular modulation type. The look-up table may be generated via, for example, lab simulation and/or field tests, and may be pre-loaded to the HSPDA enabled handset 120.

The memory 320 may comprise suitable logic, circuitry, and/or code that may enable storing of information such as executable instructions and data that may be utilized by the processor 310. The executable instructions may comprise algorithms that may be enabled to map a set of DMI diagonal loading coefficients for a selected CQI. The data may comprise the determined set of DMI diagonal loading coefficients to be used by the DMI EQ weights generator 290 and the DMI EQ 230 in the next TTI. The memory 320 may be used to store the look-up table for CQI to DMI diagonal loading coefficients mapping. The memory 320 may comprise RAM, ROM, low latency nonvolatile memory such as flash memory and/or other suitable electronic data storage.

In operation, the DMI diagonal loading factor generator 270 may be enabled to acquire information such as the signal power, receiving power, modulation type, and/or CQI information for the received signal. The DMI diagonal loading factor generator 270 may acquire the modulation type information from the channel decoder 250. The processor 310 may select a set of DMI diagonal coefficients based on the acquired information. The selected DMI diagonal coefficients in the current TTI may be used by the DMI EQ weights generator 290 and accordingly the DMI EQ 230 for the next TTI.

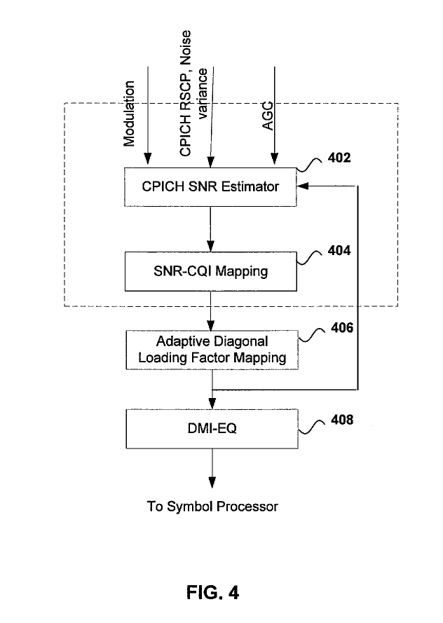

FIG. 4 is an exemplary flow chart for determining DMI diagonal loading coefficients based on CQI information, in accordance with an embodiment of the invention. Referring to FIG. 4, the exemplary steps may begin with step 402. In step 402, the DMI diagonal loading factor generator 270 may receive or acquire information on modulation type from the channel decoder 250, CPICH RSCP and noise power from CPICH processor 260, and signal power associated with the received signal from the RX Front-End 210. The SNR of the received signal may be estimated based on CPICH RSCP and noise power. In step 404, a CQI may be determined based on the estimated SNR via SNR-CQI mapping for the given modulation type as described, for example, with respect to FIG. 3. In step 406, the processor 310 may check the look-up table for the CQI-DMI diagonal loading coefficients to determine a set of DMI diagonal loading coefficients based on the determined CQI and modulation type. In step 408, the determined DMI diagonal loading coefficients may be used by the DMI EQ weights generator 290 to calculate DMI EQ weights to be used by the DMI EQ 230 for the next TTI. The output of the DMI EQ 230 may be communicated to the symbol processor 240 for further signal processing. In step 406, the processor 310 may be operable to execute step 402 to select a new set of DMI diagonal loading coefficients for following TTIs.

Aspects of a method and system for CQI based adaptive diagonal loading for DMI-EQ in HSDPA receiver are provided. In accordance with various embodiments of the invention, the HSDPA enabled handset 120 may receive a HSDPA radio signal. The HSDPA radio signal may be received in various consecutive transmission time intervals (TTI) at the receiver as described with respect to FIG. 2. The channel quality information such as the channel quality indicator (CQI) may be derived for each of the TTIs. The received radio signal may be processed at the receiver via various advanced signal processing methods such as the DMI EQ 230. The DMI EQ 230 may be implemented by using MMSE criteria together a diagonal loaded DMI to determine equalizer weights.

The DMI diagonal loading coefficients may be determined based on the derived CQI information for a current transmission time interval. The derived DMI diagonal loading coefficients may be applied to the DMI EQ 230 for equalizing the received radio signal in next transmission time interval. The derived DMI diagonal loading coefficients may be scaled by the latest AGC, which may indicate the receiving power for the received radio signal, prior to being passed to the DMI EQ 230. The CQI information may be indicated by the SNR information of the received radio signal. The SNR information may be estimated via CIPCH symbols from the symbol processor 240 in each transmission interval. The CQI for a particular modulation type may be derived from the estimated SNR.

In HSDPA enabled communication systems, the modulation information in the received radio signal may be obtained as often as every TTI via accessing the output of the channel decoder 250. Therefore, the DMI EQ 230 may be updated when the CQI information changes, that is every TTI. To reduce computational complexity in determining DMI diagonal coefficients at the DMI loading factor generator 270, a look-up table comprising mappings between various CQI for a particular modulation type and a plurality of DMI diagonal coefficients may be used. The look-up table may be preloaded in the memory 320. The processor 310 of the DMI loading factor generator 270 may select a particular set of DMI diagonal coefficients by using the look-up table for a determined CQI with a particular modulation type.

Another embodiment of the invention may provide a machine and/or computer readable storage and/or medium, having stored thereon, a machine code and/or a computer program having at least one code section executable by a machine and/or a computer, thereby causing the machine and/or computer to perform the steps as described herein for CQI based adaptive diagonal loading for DMI-EQ in HSDPA receivers.

Accordingly, the present invention may be realized in hardware, software, or a combination of hardware and software. The present invention may be realized in a centralized fashion in at least one computer system, or in a distributed fashion where different elements are spread across several interconnected computer systems. Any kind of computer system or other apparatus adapted for carrying out the methods described herein is suited. A typical combination of hardware and software may be a general-purpose computer system with a computer program that, when being loaded and executed, controls the computer system such that it carries out the methods described herein.

The present invention may also be embedded in a computer program product, which comprises all the features enabling the implementation of the methods described herein, and which when loaded in a computer system is able to carry out these methods. Computer program in the present context means any expression, in any language, code or notation, of a set of instructions intended to cause a system having an information processing capability to perform a particular function either directly or after either or both of the following: a) conversion to another language, code or notation; b) reproduction in a different material form.

While the present invention has been described with reference to certain embodiments, it will be understood by those skilled in the art that various changes may be made and equivalents may be substituted without departing from the scope of the present invention. In addition, many modifications may be made to adapt a particular situation or material to the teachings of the present invention without departing from its scope. Therefore, it is intended that the present invention not be limited to the particular embodiment disclosed, but that the present invention will include all embodiments falling within the scope of the appended claims.

What is claimed is:

1. A method of processing data, the method comprising
receiving a radio signal over a plurality of consecutive transmission time intervals;
determining channel quality information corresponding to said received signal for each of said plurality of consecutive transmission time intervals;
determining a set of diagonal loading coefficients based on said determined channel quality information; and
equalizing a subsequent radio signal received over corresponding subsequent transmission time intervals utilizing said determined set of diagonal loading coefficients.

2. The method according to claim 1, wherein said received radio signal and said subsequently received radio signal are W-CDMA signals and/or HSDPA signals.

3. The method according to claim 1, wherein said channel quality information comprises a channel quality indicator (CQI).

4. The method according to claim 1, comprising determining said channel quality information based on a received power for said radio signal and modulation information of said radio signal.

5. The method according to claim 1, comprising estimating a signal-to-noise ratio based on said radio signal.

6. The method according to claim 5, comprising deriving said channel quality information from said estimated signal-to-noise ratio.

7. The method according to claim 1, comprising updating said equalization process when said channel quality information changes.

8. The method according to claim 1, comprising determining said set of diagonal loading coefficients via a look-up table.

9. The method according to claim 8, wherein said look-up table comprises values that map channel quality information to sets of diagonal loading coefficients.

10. The method according to claim 8, wherein said look-up table is stored within a receiver that receives said radio signal.

11. A system for signal processing, the system comprising:
one or more circuits operable to receive a radio signal over a plurality of consecutive transmission time intervals;
said one or more circuits operable to determine channel quality information corresponding to said received signal for each of said plurality of consecutive transmission time intervals;
said one or more circuits operable to determine a set of diagonal loading coefficients based on said determined channel quality information; and
said one or more circuits operable to equalize a subsequent radio signal received over corresponding subsequent transmission time intervals utilizing said determined set of diagonal loading coefficients.

12. The system according to claim 11, wherein said received radio signal and said subsequently received radio signal are W-CDMA signals and/or HSDPA signals.

13. The system according to claim 11, wherein said channel quality information comprises a channel quality indicator (CQI).

14. The system according to claim 11, wherein said one or more circuits are operable to determine said channel quality information based on a received power for said radio signal and modulation information of said radio signal.

15. The system according to claim 11, wherein said one or more circuits are operable to estimate a signal-to-noise ratio based on said radio signal.

16. The system according to claim 15, wherein said one or more circuits are operable to derive said channel quality information from said estimated signal-to-noise ratio.

17. The system according to claim 11, wherein said one or more circuits are operable to update said equalization process when said channel quality information changes

18. The system according to claim 11, wherein said one or more circuits are operable to determine said set of diagonal loading coefficients via a look-up table.

19. The system according to claim 18, wherein said look-up table comprises values that map channel quality information to sets of diagonal loading coefficients.

20. The system according to claim 18, wherein said look-up table is stored within a receiver that receives said radio signal.
